(19) United States
(12) Patent Application Publication
(10) Pub. No.: US 2005/0135560 A1
(43) Pub. Date: Jun. 23, 2005

(54) Portable computed tomography scanner and methods thereof

(76) Inventors: Ehud Dafni, Caesarea (IL); Eliahu Heyman, Newton Center, MA (US)

Correspondence Address: ALTMAN & MARTIN, 6 BEACON ST, STE 600, BOSTON, MA, 02108, US

(21) Appl. No.: 10/740,387

(22) Filed: Dec. 17, 2003

(51) Int. Cl. H05G 1/10

(52) U.S. Cl. 378/101

(57) ABSTRACT

A computed tomography scanner includes a base system and a rotor system. The rotor system has an axle that is rotationally mounted to the base system. At least one x-ray source is mounted to the rotor system. A power interface system at least partially disposed about the axle couples power to the x-ray source. The power interface may include a slip ring assembly or a cable assembly that winds and unwinds about the axle as the rotor system rotates.

### CROSS-REFERENCES TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention relates to computed tomography (CT) scanners, more particularly, to portable CT scanners designed for use outside the typical diagnostic environment or where the examined subject is small.

2. Description of the Related Art

Computed tomography is a diagnostic procedure that uses special x-ray equipment to obtain cross-sectional axial images of a subject. The general classification of CT scanners is based upon the arrangement of components in the scanners and the mechanical motion required to collect data. The term “generation” with an associated number is applied to the CT scanners discussed below because of the order in which these designs were introduced. However, a higher generation number does not necessarily mean a higher performance system. Each generation scanner has a variety of advantages, including speed of data acquisition, as well as disadvantages, such as cost and susceptibility to imaging artifacts.

Typically, first generation CT scanners have a single x-ray source, which is rigidly connected to a single x-ray detector. To collect one slice of imaging data, a pencil beam x-ray is passed from the source through the subject to the detector cell. The source and the detector are then moved slightly with respect to the subject and another pencil beam x-ray is passed from the source through the subject to the detector. This process is repeated until the necessary data is collected.

Second generation CT scanners have an x-ray source rigidly connected to an array of x-ray detectors. The detectors all lie within the same scan plane, but are not necessarily contiguous nor do they span the entire circumference of a subject being examined. To collect one slice of imaging data, the x-ray source emits radiation over a large angle through the subject, which is captured by the array of detectors. The source and the array of detectors are moved slightly with respect to the subject and the x-ray source emits radiation again over a large angle through the subject, which is captured by the array of detectors. This process is repeated until the necessary data is collected. Since the second generation CT scanner is able to capture multiple projections of radiation for each emission, the second generation CT scanner is significantly more efficient and faster than the first generation CT scanner.

Third generation CT scanners have an x-ray source which is rigidly fixed to an array of x-ray detectors and the source and detectors are mounted for rotational movement about an axis. The array of detectors is large enough to allow the simultaneous measurement of an x-ray projection of the entire cross-section of the subject. To collect one slice of imaging data, the source and the array of detectors are rotated about the subject taking projection data throughout each revolution.

Fourth generation CT scanners have an x-ray source mounted for rotational movement about an axis and a stationary ring of detectors so there is a detector opposing the rotating x-ray source at each angle. To collect one slice of imaging data, the source is rotated about the subject and radiation emitted from the source throughout each revolution is captured by the ring of detectors.

There are some variations for each of the generations of CT scanners discussed above. For example, the CT scanners discussed above may use a half a rotation or several rotations about the subject to obtain one slice of imaging data. As another example, the CT scanners discussed above may have multiple arrays of detectors or multiple x-ray sources to acquire multiple slices of imaging data simultaneously.

In each of the generations of CT scanners discussed above, in order to obtain an image of the entire subject or a section of the subject, the subject is translated axially through the patient aperture by a motorized platform resembling a couch or bed. The translation may be in discrete steps (“step and shoot” mode) or in a continuous motion (spiral mode).

Since the subject needs to be moved through the aperture of these CT scanners, all of the components of the CT scanners are built around the aperture for the subject. These components include (1) the main bearing or other mechanical rotor support system, (2) the rotor drive system utilizing a motor or a belt, (3) cables, slip rings, and data links that transfer power and data to and from the rotor, and (4) rotational encoders or resolvers used to measure the angular position of the rotor.

To permit a subject to pass into these CT scanners a large diameter opening is required, but this larger opening complicates the design of the components for the CT scanners, making them more expensive. Additionally, for a given angular rotation velocity, the linear velocity of some interfacing components, particularly the bearing and slip rings, is large, limiting the scanner speed and resulting in noise and rapid wear. Further, because it is difficult and expensive to transfer the high voltages required by the x-ray source through large diameter slip rings, modern CT scanners have the high voltage generator mounted directly on the rotor, further complicating the design. Also, because it is difficult to transfer cooling liquid to and from the rotor, removal of heat generated on the rotor is accomplished by air flow, which is less efficient than liquid cooling.

Most of these large diameter CT scanners generate scattered radiation during operation. Therefore, they need to be installed in special radiation shielded rooms or otherwise provide suitable radiation shielding to onlookers, operators, and patients during operation. Personnel need to be located outside of the scan room during the scan or must wear radiation protective clothing. Further, personnel must be continuously monitored for exposure to ionizing radiation from the CT scanner as cumulative effects may be harmful as well.

Prior CT scanners have also failed to address the inability to perform CT scans on critically ill patients in intensive care units or operating rooms who are too sick to transport to Radiology for a CT scan. The movement of critically ill patients for imaging studies can endanger the patient since such patients are often physiologically unstable, require accurate and on-going monitoring of their physiologic functions, may be receiving precisely controlled intravenous medications, such as vasopressors, and may have spinal injuries that could be aggravated by movement.

Additionally, in cases of patients with known or suspected major craniocerebral injury, there is often no time to transfer the patient from the trauma bed to the CT scanner couch to perform the CT scan. Often, the minutes required to transfer the patient would result in diminished outcomes or even death. Further, time is often wasted in disconnecting and re-connecting life support equipment, intravenous hydration solutions and medications, and physiological monitoring equipment, as part of the transfer to the CT scanner bed. Some intensive care unit patients, such as those receiving continuous hemofiltration, jet-ventilation, extra-corporeal lung assist, aortic balloon counterpulsation or other invasive support, cannot be transported. Movement of any intensive care unit patient requires physicians, nurses, respiratory therapists, and other support staff, all at increased cost and with increased risk to the patient. Similar challenges exist when attempting to assess diagnostic results in a surgical setting such as in the operating room or in the management of acute cerebral trauma cases requiring surgery.

A CT scanner with a gantry structure that overcomes some of the disadvantages discussed above is made by Analogic Corp. of Peabody, Mass. Some versions of this CT scanner have a gantry body that has a range of tilting motion of up to sixty degrees, so a patient's head may be scanned by altering the angle of the gantry to cover an anatomical area of interest. However, for patients with relatively smaller necks, and for those patients who suffer from head or neck trauma that make accurate positioning of the head and neck impossible, adjusting the gantry tilt angle may not sufficiently cover the entire area of interest. With this CT scanner, no movement of the subject is needed to image a volume of the subject. The CT scanner is connected to an external power source, but is also provided with a rechargeable battery to boost the power during scan. The battery is mounted on the rotor, requiring the rotor to go to a “park” position for re-charging. Some versions of this CT scanner have wheels that make it portable.

### SUMMARY OF THE INVENTION

A scanner in accordance with embodiments of the present invention includes a base system and a rotor system. The rotor system has an axle that is rotationally mounted to the base system. At least one x-ray source is mounted to the rotor system. A power interface system at least partially disposed about the axle couples power to the x-ray source.

A scanning system in accordance with embodiments of the present invention includes a base system, a rotor system, and a power source. The rotor system has an axle that is rotationally mounted to the base system. At least one x-ray source is mounted to the rotor system. A power interface system at least partially disposed about the axle couples power from the power source to the x-ray source.

A method for making a scanner in accordance with embodiments of the present invention includes providing a base system and a rotor system. The rotor is provided with an axle that is mounted to the base system for rotational movement. At least one x-ray source is mounted to the rotor system. A power interface system is provided that is at least partially disposed about the axle and that couples power to the x-ray source.

A method for making a scanner in accordance with embodiments of the present invention includes providing a base system, a rotor system, and a power source. The rotor is provided with an axle that is mounted to the base system for rotational movement. At least one x-ray source is mounted to the rotor system. A power interface system is provided that is at least partially disposed about the axle and that power from the power system to the x-ray source.

The present invention provides a portable CT scanner which can be brought directly to the patient, enabling CT scanning without moving the patient from their hospital bed. As a result, with the present invention critical CT scans can be performed more quickly and with less risk to the patient resulting from unnecessary movement of the patient. Further, critically ill patients who previously were not candidates for CT scans can now have images generated of anatomical regions, such as the head and neck areas, to aid in rapid diagnosis.

The reduced size of the CT scanner in accordance with the present invention also makes it truly portable, affording a mobile CT system that may be moved from room to room or from bed to bed as the diagnostic imaging needs of patients are assessed. The reduced size of the CT system further reduces the radiation shielding requirements which enables the scanner to be operated in areas without traditional radiation shielding.

The present invention also incorporates a head and neck support system for the patient which establishes known reference points between the CT system and the patient support to enable precise and repeatable scans as may be necessary in an operating room environment to repeatedly monitor on-going surgical procedures and assess the results of emergency craniotomies in head trauma cases, for example.

Further, the system and method of the present invention allows the display and manipulation of the captured images, presenting clinically useful images for use in immediate patient diagnosis and treatment decisions.

### BRIEF DESCRIPTION OF THE DRAWINGS

FIG. 1A is a side, cross-sectional view of a CT scanner of the present invention;

FIG. 1B is a front, cross-sectional view of the CT scanner of FIG. 1A;

FIG. 2A is a side, cross-sectional view of a CT scanner of the present invention utilizing an alternate detector assembly embodiment;

FIG. 2B is a front, cross-sectional view of the CT scanner of FIG. 2A;

FIG. 3 is a side, cross-sectional view illustrating an alternate embodiment of a CT scanner of the present invention;

FIG. 4 is a block diagram of a CT scanner system of the present invention;

FIG. 5 illustrates an alternate slip ring apparatus for transferring high voltage power to the rotor in a CT scanner of the present invention;

FIGS. 6A and 6B are diagrams of a cable alternative to the slip ring apparatus of FIG. 5;

FIGS. 7A, 7B, and 7C show several configurations of the subject head support platform for use with the CT scanner system of the present invention; and

FIG. 8 shows a configuration of the radiation shield for use with the CT scanner of the present invention.

### DETAILED DESCRIPTION OF THE INVENTION

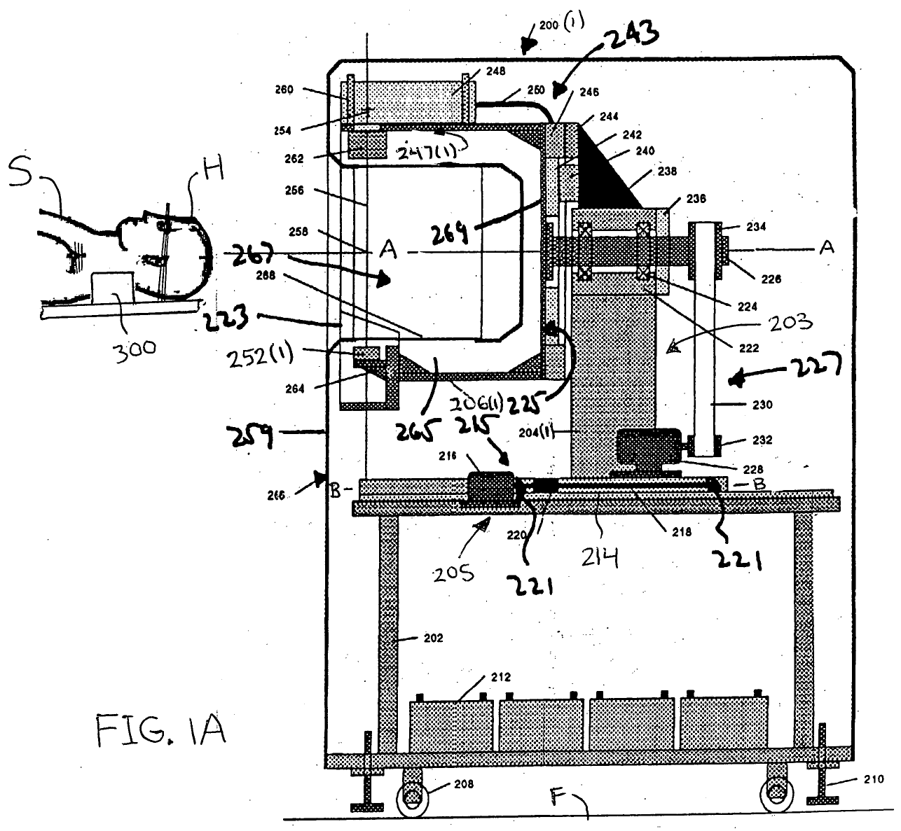

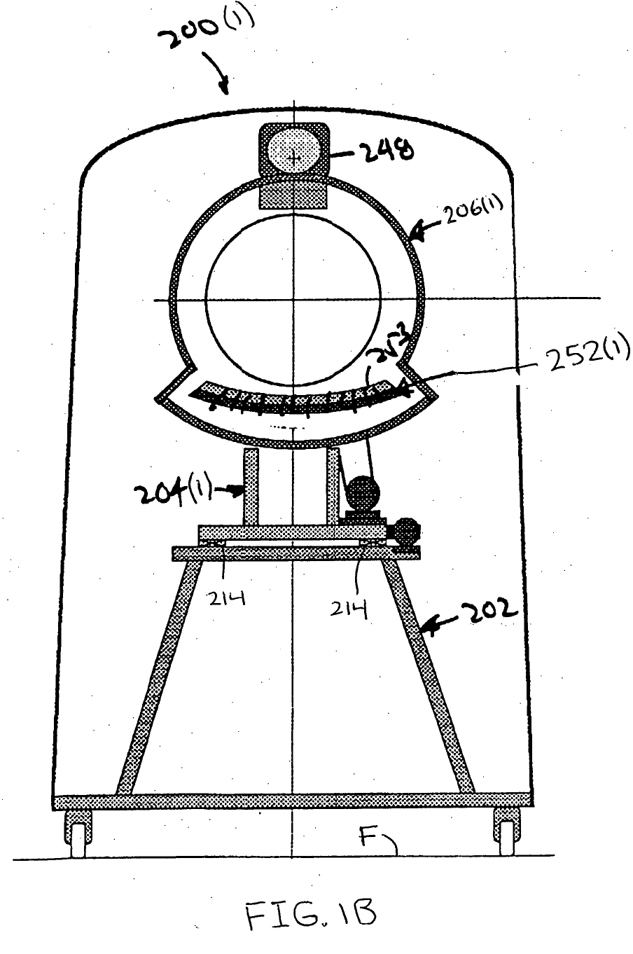

A CT scanner 200(1) in accordance with embodiments of the present invention is illustrated in FIGS. 1A and 1B. The CT scanner 200(1) includes a base 202, carriage system 204(1), and rotor system 206(1) with an x-ray source 248 and a detector assembly 252(1), although the CT scanner 200(1) can comprise other numbers and types of components, devices, and systems, such as power conditioning assemblies and x-ray tube cooling assemblies, in other configurations. The present invention provides a portable CT scanner 200(1) which can be brought directly to the patient, enabling CT scanning without moving the patient from their hospital bed.

Referring to FIGS. 1A and 1B, an embodiment of the portable CT scanner 200(1) is illustrated. Since the standard components of CT scanners along with their connections and operation are well known, only the major components of the CT scanner 200(1) that are related to the present invention are described in detail herein.

The base 202 is a cart-shaped structure which supports the carriage system 204(1), rotor system 206, and other components, both required and optional, of the CT scanner 200(1), such as batteries 212, power conditioning and control systems, and cooling system, although the base 202 could have other shapes and configurations and could support and house other devices.

The base 202 includes wheels 208 which are connected to the cart-shaped structure which can be used to move the scanner 200(1) into position to scan a portion of the anatomy, such as the head H of subject S, although other types of devices for making the base 202 mobile can be used or the base 202 may be not have any type of mobility system. The base 202 may also include other components to enhance the mobility and control of positioning the CT scanner 200(1), such as a motor to drive the wheels, a steering system, and a braking system.

The base 202 is also provided with jacks 210 which are used to stabilizing the CT scanner 200(1) during a scanning operation when the jacks 210 are extended, although other types of stabilizing devices could be used or could be left off of the base 202.

The batteries 212 are coupled to and can be used to supply power to one or more devices of the CT scanner 200(1), such as the x-ray source 248 and a detector assembly 252(1). For example, the batteries may provide additional power to one or more devices of the CT scanner 200(1) when demand increases during a scan operation. In another example, the scanner 200(1) may be unplugged from a remote external power supply altogether and operated for a limited time using only batteries 212. This feature further improves the portability of the scanner 200(1) as used in a clinical setting. The batteries 212 can be recharged during breaks between scans.

The base 202 also includes a scanner cover 266 that provides a protective external shell for the scanner 200. The cover 266 is mounted on a frame supported by base 202. The cover 266 forms a cavity 267 that extends into the scanning region within the rotor system 206. As shown in FIGS. 1A and 1B, the cavity 267 is 30 cm in diameter and 30 cm deep beyond slice plane 256 when carriage system 204 is in the front-most position. A depth of 30 cm provides a 20 cm scanning range plus a 10 cm free space beyond the limits of the subject S, accommodating patients with attached surgical devices such as stereotactic surgical appliances, intravenous medication delivery equipment, and other devices that may lie near the anatomical region of interest. The cover 266 may be made of any rigid material such as fiberglass or a polycarbonate composite. The cylindrical section 268 intersecting slice plane 256 in the entire range of the carriage translation is made of an x-ray transparent material, such as polycarbonate, so that the cover 266 does not attenuate the x-ray beam, create image artifacts, or otherwise negatively affects the imaging process.

CT scanners generate heat, particularly during operation of the x-ray tube. A common solution to removing heat from the x-ray tube is to provide it with a heat exchanger. Accordingly, an oil to air heat exchanger is mounted on the rotor system 206 to remove heat from the x-ray source 248. The resultant hot air is vented from within the cover 266. Further, the x-ray source 248 may be cooled by an oil to water heat exchanger and the heat removed by circulating cold water to and from the rotor system 206. Suitable rotating fluid joints may be used to facilitate the heat exchange.

The carriage system 204(1) includes a carriage structure 203 and a linear motion system 205, although the carriage system 204(1) can comprise other numbers and types of devices and systems in other configurations. The carriage structure 203 has a bearing housing 222 located at one end. Two sets of rotational bearings 224 are mounted in the bearing housing 222 to provide the rotor system 206 with stability during rotation and comprise a pair of single row angular contact ball bearings, although other types and numbers of bearings in other arrangements can be used. The bearings 224 in the bearing housing 222 support an axle 226 for rotational movement about a rotation axis A-A.

The bearings 224 employed by the present invention are substantially smaller, easier to manufacture at the required precision, and less expensive than the main rotational bearing used in previous CT scanners because of the reduced size of the portable CT scanner 200(1). In previous CT scanners, the main bearing is installed around the large diameter gantry aperture, which is normally 60 cm, whereas in the present invention the bearings 224 are installed around a small diameter axle 226. Therefore, for a given angular velocity of the rotor system 206, for example, one revolution per second, the linear velocity of the bearing components is substantially less than the linear velocity in the bearings of previous CT scanners. Consequently, the acoustic noise generated by the rotation is smaller, and the wear of the components is reduced in the CT scanner 200(1).

The axle 226 extends from the outer surface of the closed end 225 of drum 247(1) coaxial with the rotation axis A-A. Generally, the diameter of the axle 226 is smaller than the outer diameter of the drum 247(1). Another end of the carriage structure 203 is connected to a linear motion system 205 that moves the carriage system 204(1) and the rotor system 206 linearly along a linear axis B-B. The rotation axis A-A and the linear axis B-B are substantially parallel to each other, although other configurations can be used, such as having the rotation axis A-A at an angle with respect to the direction of the linear axis B-B.

The linear motion system 205 includes linear sliding rails 214 and a carriage drive system 215, although the linear motion system 205 can comprise other numbers and types of devices and systems in other configurations. The linear sliding rails 214 are mounted on the base 202 and allow the carriage structure 203 of the carriage system 204(1) to travel linearly relative to the base 202. The range of travel depends upon the linear range over which the scanner 200(1) is intended to operate. By way of example, the linear range may be about 20 cm.

The carriage drive system 215 includes a motor 216 mounted on the base 202, a lead screw 218 coupled to the motor 216, and a nut 220 mounted on the lead screw 18, although the carriage drive system 215 can comprise other numbers and types of devices and systems in other configurations. The motor 216 is a DC electrical motor, although other types of motors, such as an AC electrical motor or any other type of rotational motor, could be used. The motor 216 is directly coupled to the lead screw 218 or via a gear assembly. As the motor 216 rotates the lead screw 218, the screw threads cause the nut 220, the carriage system 204(1), and the rotor system 206 to move linearly on the rails 214. By way of example, an alternative embodiment for the carriage drive system 215 could have a linear motor, a position encoder, sensors which signal the two end positions or the position of carriage system 204(1) relative to base 202.

The rotor system 206 includes a circular drum 247(1), a rotor drive system 227, a rotational encoder 236, a collimator 262, the x-ray source 248, and the x-ray detector assembly 252(1), although the rotor system 206 can comprise other numbers and types of devices and systems in other configurations.

The circular drum 247(1) has a hollow interior 265 with an open end 223 and a closed end 225. The wall of the closed end 225 is generally perpendicular to the rotation axis A-A. This structure is rigid and helps to minimize radiation exposure to others in the room when the CT scanner 200(1) is in operation. Although a circular drum 247(1) is shown, other types of structures that can support the x-ray source 248 and the x-ray detector assembly 252(1) relative to the rotation axis A-A may also be used, including closed or opened-end structures with other cross-sectional shapes, such as circular, triangular, hexagonal, and octagonal. Additionally, the closed end 225 of the drum does not have to be completely closed. It may consist merely of struts up to a completely solid surface as long as it provides a rigid foundation for the axle 226. Additionally, the wall of the drum 247(1) does not have to completely encircle the interior. A section of the drum 247(1) opposite the x-ray source 248 may be open.

In order to allow a subject S to lay in a more comfortable and convenient position, the rotation axis A-A may be adjusted to a tilted position, typically about 70 to 100 above horizontal, although other angles could be used. This tilt can be achieved in a number of ways. For example, the rotor system 206 can be mounted at a fixed angle relative to the carriage system 204(1) or can include an angular position adjustment system, such as an adjustable bracket system or and electromechanical adjustment system, that allows the angle of the rotor system 206 to be adjusted to one position or to a continuously changing angular position. In an alternative example, the entire carriage system 204(1) may be mounted at an angle relative to the floor F.

The rotor drive system 227 includes a motor 228 mounted to the carriage system 204(1), a motor pulley 232 driven by the motor 228, an axle pulley 234 mounted to the axle 226, and a belt 230 between the motor pulley 232 and the axle pulley 234. The motor 228 is a DC electrical motor, although other types of motors such as an AC electrical motor or an other type of rotational motor, could be used. The motor 228 is directly coupled to the motor pulley 232, although other manners for coupling the motor 228 to the pulley 232 could be used, such as via a gear assembly. In an alternative example, the rotor drive system 227 may comprise a ring motor mounted on carriage system 204(1) and which is directly coupled to axle 226.

The rotational encoder 236 is connected to the carriage system 204(1) and measures the angular position of the rotor system 206. The rotational encoder 236 provides an absolute angle reading with a precision of at least 0.50 and a relative angle reading with precision of at least 0.005°. Within these limits, accuracy of rotor movement and positioning is ensured, and likewise image quality and repeatability of scans.

A collimator 262 is connected to the drum 247(1) and is used to adjust the x-ray beam from the x-ray source 248 to a fan shape with the desired fan angle and width, although other types of devices for adjusting the x-ray beam could be used. Collimation is achieved in the collimator 262 by metal blades made of highly-x-ray absorbent materials. Optionally, the collimator 262 includes a bowtie filter and other radiation filters depending upon the slice profile desired.

The x-ray source 248 and the detector assembly 252(1) are connected to the drum and are spaced from each other and from the rotation axis A-A. A plane perpendicular to the rotation axis A-A is formed along the line of an x-ray beam extending from a focal spot 254 in the x-ray source 248 to an arc of detector elements 253 in the detector assembly 252(1). This plane is referred to as slice plane 256. The center of rotation 258 is the point of intersection between the slice plane 256 and rotation axis A-A.

The x-ray source 248 and the detector assembly 252(1) are mounted on the rotor system 206 and rotated about subject S. In FIG. 1A, the CT scanner is in the process of being positioned about the head H of subject S so the slice plane 256 extends through the region of interest in the subject. A single image slice or multiple image slices, depending upon the structure of the detector assembly 252(1), are obtained in one revolution of the rotor system 206. In order to image the entire subject S, the subject S and the rotor system 206 are translated axially relative to each other.

The x-ray source 248 is an x-ray tube mounted and aligned on the drum 247(1) with brackets 260. The x-ray source 248 may be a single-ended tube, for example with the anode at ground potential and the cathode at −120 KV, or the x-ray source 248 may be a dual-ended tube, with the anode at +60 KV and the cathode at −60 KV, although other types of x-ray sources 248 can be used, such as a rotating anode tube or a fixed target tube. The focal spot 254 is positioned asymmetrically with respect to the length of the x-ray source 248 so that the slice plane 256 is positioned as near to the scanner front surface 259 as practical when the carriage system 204(1) is in the front-most position.

As shown in FIGS. 1A and 1B, the x-ray detector assembly 252(1) comprises an arc of x-ray detector elements 253 that is mounted and aligned on the rotor system 206 with a support structure 264. The detector assembly 252(1) includes a single arc of detector elements 253 that acquires a single slice of data per x-ray exposure, although other types of detector assemblies can be used, such as one with two or more parallel arcs of detector elements that acquire two or more slices of data per x-ray exposure. The detector assembly 252(1) may be made of scintillator crystals coupled to silicon photodiodes or any other appropriate detector assembly type, for example, photomultiplier tubes. Further, the detector assembly 252(1) may include an anti-scatter grid collimator.

Due to the unique size and manner of practicing the present invention, the approach to signal and power transfer methods is also unique to the present invention. To facilitate signal transfer both to and from the rotor system 206, there are a number of interfaces that may be employed. Power interface systems include, for example, slip rings and cables, while interface systems for transferring control and data signals include, for example, wired interfaces such as slip rings and cables, as well as wireless interfaces such as optical coupling, radio frequency transmission, and inductive and capacitive coupling, all of which are well-known as methods for transferring information.

A power interface system is shown in FIG. 1A, and includes a bracket 238 is mounted on the carriage system 204(1) to support a contact array 244 which is coupled to a disc-like slip ring 246 mounted to the outer surface 225 of the rotor system 206. Also, the slip ring assembly may be cylindrical and built around the axle 226.

The slip ring assembly 243 is used to transfer high-voltage power from the high-voltage power source 194 mounted on the base 202 to the x-ray source 248. Alternatively, a high-voltage generator may be mounted on the rotor system 206 as a separate unit or in a “monoblock” configuration as a combined unit with the x-ray source 248. In this fashion, power at low voltage (up to several hundred volts) is transferred to the rotor system 206 and converted to high voltage directly on the rotor system 206.

If the x-ray source 248 is a single-ended x-ray tube, only one voltage relative to ground is necessary. Correspondingly, the high-voltage slip ring assembly 243 may be designed for a single voltage transfer. A typical single-ended tube voltage for scanning a human head is approximately 120 KV, the polarity depending on the structure of x-ray tube. However, if the x-ray source 248 is a dual-ended x-ray tube, requiring both negative and positive voltages, the high voltage slip ring must be designed to provide both positive and negative voltages. Typical dual-ended x-ray tube voltages for scanning a human head are approximately +60 KV and −60 KV.

While the present invention permits the use of substantially smaller diameter and lower cost rotational encoder 236 and slip ring assemblies 243 than previously used in CT scanners, an alternate power interface system is illustrated in FIG. 5. The high-voltage connection is constructed at the center of rotation, as opposed to previous designs built around the gantry aperture. In the high-voltage connection of FIG. 5, the x-ray source 248 is a single ended x-ray tube. Three leads 702 are provided, one for a reference high voltage and two for carrying the filament current. While many similar designs may support other voltage and lead configurations depending upon the type of x-ray tube and manner of supplying high voltage and filament current, for illustrative purposes as shown in FIG. 5, and for brevity, a single ended x-ray tube with a three lead configuration is shown.

The axle 226 is used to support the rotor system 206 as described previously with reference to FIG. 1A. An electrical multiconductor plug 706 at the end of a cable 708 carrying three leads 702 is mounted on the axle 226. The plug 706 is extended by an insulator 710 made of a high dielectric material such as a dielectric ceramic. The insulator 710 is mounted within the cavity 726 in the axle 226. At the end of the insulator 710 is a set of slip rings 712, one ring for each of three leads 702, made of conductive material and connected to the appropriate contacts of the plug 706. Mating spring-loaded brushes 714 are mounted in a brush block 716, which is mounted to the axle 226. The brush block 716 is connected to a cable 718, which transfers the three signals to the x-ray source. Alternatively, the rings may be mounted on the axle while the brushes may be mounted on the insulator. Likewise, the slip rings may be positioned on the face 719 of the insulator 710 around the center of rotation rather than on the side of the insulator 710.

The axle cavity 726 is fitted with an insert 720 made of a high-dielectric material as well. The insert 720 has one or more spark barriers 722 and the insulator 710 has one or more spark barriers 724. Optionally, the cavity 726 between the insulator 710 and the insert 720 is filled with an insulating liquid or gas. A retainer ring 727 and seal 728 retain liquid or gas within the cavity 726. A bearing 730 is provided between the carriage system 204 and the rotor axle 226 in order to maintain accurate positioning of the insulator 710 at the center of rotation. Without the bearing 730, the insulator 710 may wobble, causing the brushes 714 to intermittently lose contact with the slip rings 712 during rotation. Additionally, the seal 728 may not retain the insulating liquid or gas and the system wear will be high. The bearing 730 may be used in any combination of the high-voltage connections as well as signal connections. Additional bearing sets may also be used to support the rotor system 206 relative to the carriage system 204. Similarly, the insulator 710 may be mounted to the axle 226 and the brush block 716 may be mounted to the carriage system 204 with similar results.

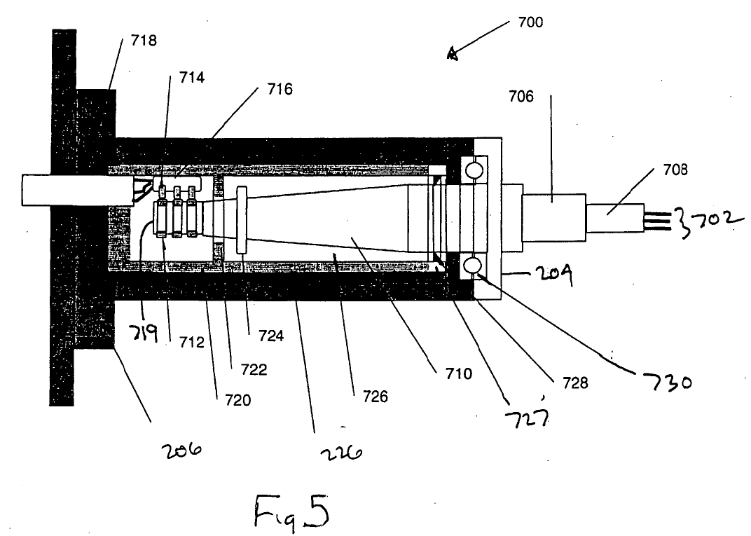

Additionally, power and, optionally, control and/or data signals may be transferred by one or more cables in a bundle rather than by slip ring assemblies. As shown in FIGS. 6A and 6B, the rotor system 206(1) is permitted only a limited range of rotation, for example 540 degrees. The cables 506 are sufficiently long that when the rotor system 206(1) rotates in one direction, the cables 506 wrap around the axle 226. When the rotor system 206(1) rotates in the opposite direction, the cables 506 unwrap. Additionally, the cables 506 may be supported by a cable carrier assembly 508.

Referring to FIGS. 6A and 6B, the cables 506 are shown in a completely wound state and a completely unwound state, respectively. The cables 506 are supported by a carrier assembly 508 and are anchored on one side to a block 510 mounted on the carriage 204. The opposite end of the cables 506 is anchored to the block 512 mounted on the rotor system 206(1) adjacent to the axle 226. As a lower cost alternative to slip ring technology, the design illustrated in FIGS. 6A and 6B is advantageous over previous methods of providing signal and power terminations by cables since the cables 506 in the present invention need not wrap around a large diameter ring build around a gantry bore, but rather only around the small diameter axle 226, thereby simplifying construction and manufacture. Regardless of the manner in which power, signal, data, and control signals are distributed, it is imperative that a robust manner of furnishing these signals to the rotor is provided.

In addition to the unique configuration of the CT scanner system of the present invention, the ability to provide stable, comfortable, and repeatable positioning of a patient is essential in exploiting the inventive features of the present invention. Proper positioning of the head and neck of critically ill patients is crucial to realizing the efficacy of the present invention.

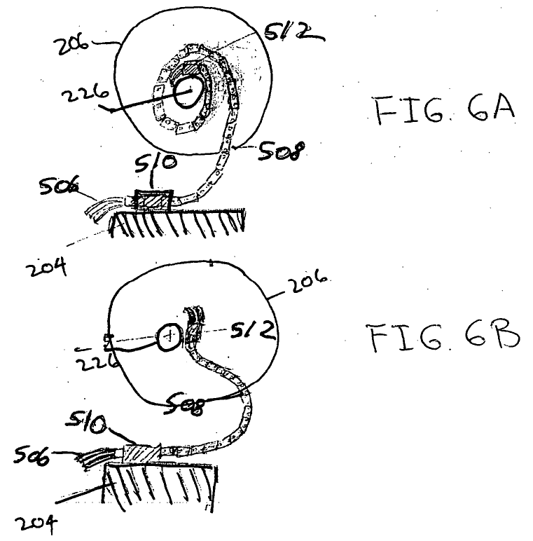

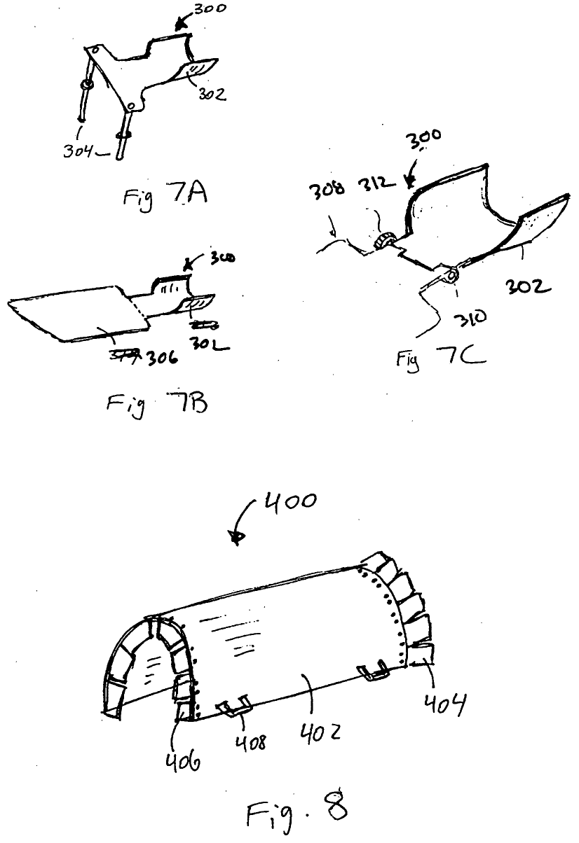

FIGS. 7A, 7B, and 7C illustrate several configurations of a platform 300 used in connection with the scanner 200 to provide a rigid and stable support for the head of the subject S during scanning. With adequate head and neck support, the subject S may be scanned in the scanner 200 without the need to transfer the subject S to a special CT bed/couch prior to performing the scan. Without the need for transferring the subject S to a special bed, CT scans may be performed on critically ill patients who were previously not candidates for CT scanning.

Referring to FIGS. 7A, 7B, and 7C, a head section 302 is structured to fit into scanner cavity 267 and is composed of an x-ray transparent material such as polycarbonate or a composite material reinforced by carbon fiber to minimize the effect on the imaging process. The head section 302 may be supplemented with cushions and straps for stabilizing the subject's head H during scanning. As shown in FIG. 7A, poles 304 are used to mount the platform 300 on a hospital bed using the mounts for IV poles. In FIG. 7B, a flat section 306 is inserted underneath the subject S, so the platform 300 is balanced by the subject's weight. Additionally, the flat section 306 may be lined with radiation absorbing material to help reduce scatter radiation in the vicinity. In FIG. 7C, a hinge 310 between the head section 302 and the flat section 308 provides for a variety of tilt angles of the head section 302 relative to the slice plane 256. A knob 312 is used to lock the head section 302 at the desired angle. In this fashion, the subject S may be scanned without being transferred to a special bed.

While a shielding platform 300 will help reduce scatter radiation, the outer surface 271 and inner surface 269 of the drum 247 may also be coated with a 2 mm to 3 mm thick layer of lead or other x-ray absorbent material of the appropriate thickness to absorb scatter radiation from the scanned subject S and from the assemblies on rotor system 206. Due to the closed design of the scanner 200, scatter radiation is greatly reduced over previous CT scanners with the majority of it occurring forward of the slice plane 256 since the back of the scanner is closed and shielded. However, even with the cup design of the present invention, scatter radiation may be further reduced by employing a radiation shield 400 as shown in FIG. 8.

FIG. 8 shows a radiation shield 400 for use with the scanner 200. The shield body 402 is made of an x-ray absorbing material, such as lead acrylic. The shield 400 is placed over the subject S during scanning to reduce scatter radiation from reaching subject S. Additionally, the shield 400 may have flexible flaps 404 to adjoin the scanner face 259 and flexible flaps 406 to further shield the subject S. The flaps 404, 406 may be composed of a synthetic rubber or polyvinyl chloride mixed with lead powder. Handles 408 are provided on shield 400 to facilitate moving and positioning.

With the above-described configuration of the present invention, the subject S remains on a non-specialized CT bed while the scanner is operated. An image capture assembly comprises the carriage system 204(1) and the rotor system 206(1) and is sized to make the CT scanner 200(1) portable. In particular, the image capture assembly is sized to be less than about one meter wide by one meter high by one meter in depth, although other dimensions for the image capture assembly can be used.

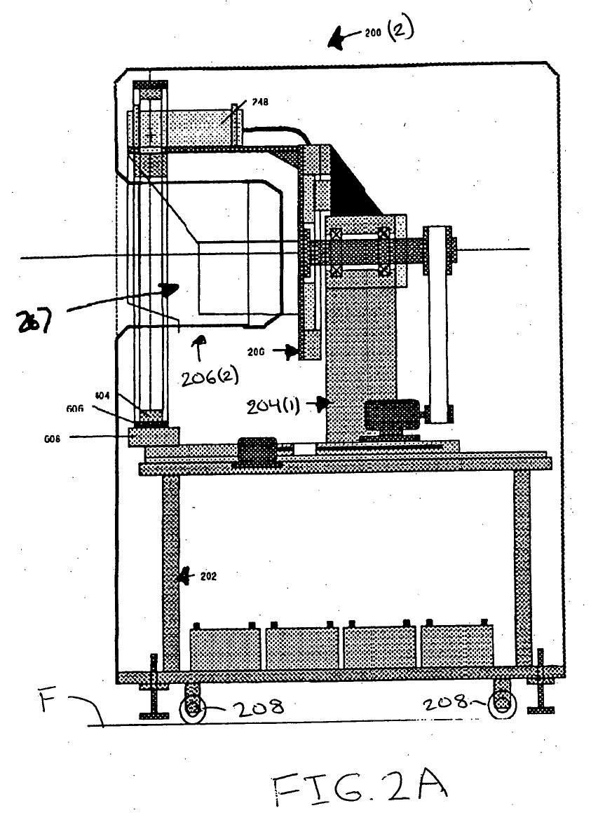

A fourth generation CT scanner 200(2) according to the present invention is illustrated in FIGS. 2A and 2B. The fourth generation CT scanner 200(2) is identical to the third generation CT scanner 200(1) as described with reference to FIGS. 1A and 1B, except as described below. Elements in FIGS. 2A and 2B which are like those in FIGS. 1A and 1B will have like reference numerals.

In the embodiment shown in FIGS. 2A and 2B, a fourth generation CT scanner is shown where the detector assembly 252(2) is a complete ring 604 of detector elements 605 mounted outside of the rotor system 206. At any angle of the rotor system 206(2), there is an arc of opposing detector elements 605 responsive to radiation from the x-ray source 248. The detector ring 604 is supported by a circular frame 606 mounted to the carriage system 204(1) by support 608. Additionally, the wall of the drum 247(2) of the rotor system 206 does not completely encircle the interior and has a open-ended, partial hexagon shape. In particular, the section 610 of the drum 247(2) of the rotor system 206 opposite the x-ray source 248 is open.

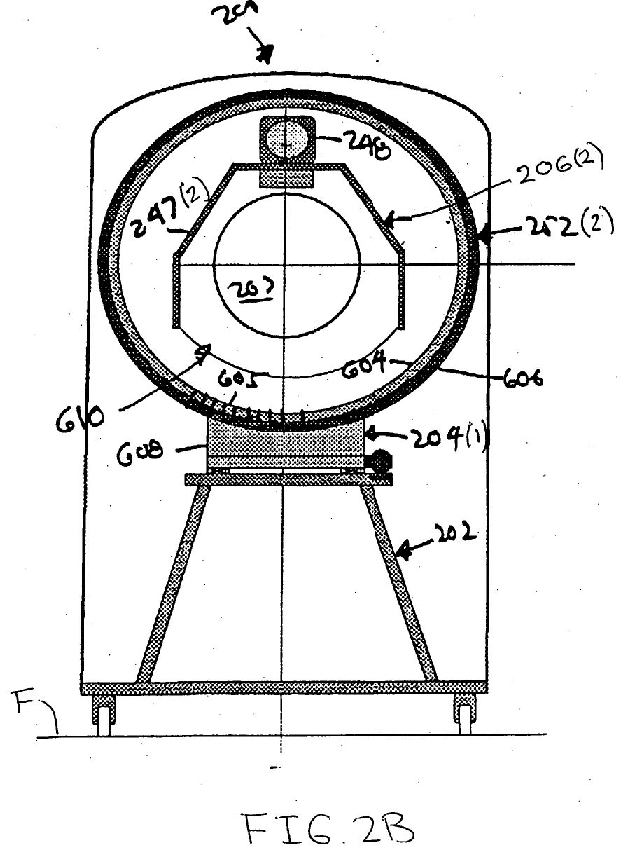

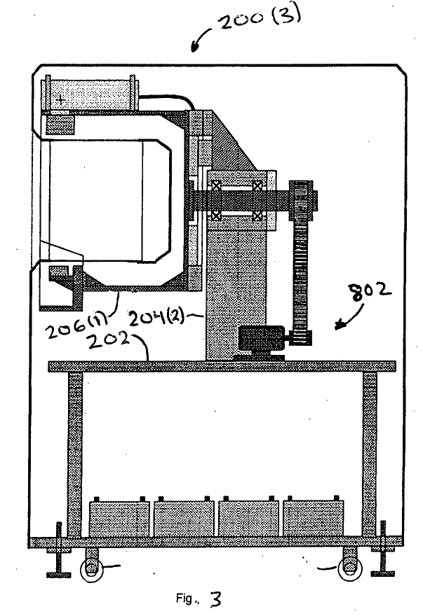

Referring to FIG. 3, a CT scanner 200(3) in accordance with other embodiments of the present invention is shown. The CT scanner 200(3) is identical to the CT scanner 200(1) described with reference to FIGS. 1A and 1B, except as described below. Elements in FIG. 3 which are like those in FIGS. 1A and 1B will have like reference numerals. The carriage system 204(2) in the CT scanner 200(3) does not have the linear motion system 205. The base 202 and carriage system 204(2) are combined into a single stationary pedestal 802. The CT scanner 200(3) may be used when the subject S is on a bed which translates the subject relative to the scanner 200(3). Like the CT scanner 200(1) of FIGS. 1A and 1B, the rotor system 206 (1) has a position adjustment system, such as adjustable brackets or a motorized electromechanical system, for adjusting the angle of the rotor system 206(1) with respect to the carriage system 204(2) and the base 202.

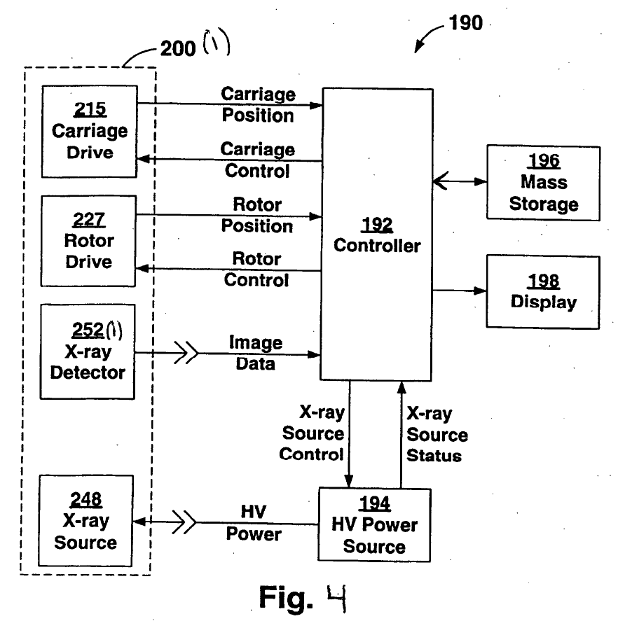

Referring to FIG. 4, a scanning system 190 in accordance with embodiments of the present invention is illustrated. Elements in FIG. 4 which are like those in FIGS. 1A and 1B will have like reference numerals. The scanning system 190 includes a controller 192 which is coupled to the CT scanner 200(1), high-voltage power source 194, mass storage or memory 196, and video display 198, although the scanning system 190 can comprise other numbers and types of systems, devices, and components, such as the CT scanner 200(2) or the CT scanner 200(3), which are coupled together in other configurations. The controller 192 includes one or more processors for executing programmed instructions for one or more aspects of the present invention as described herein, including programmed instructions for controlling the operation of a CT scanner and processing data to generate images from captured radiation in manners well known to those of ordinary skill in the art. The programmed instructions are stored in mass storage device 196 for execution by the processor in controller 192, although the instructions could be stored in other locations. A variety of different types of memory storage devices can be used for mass storage 196 and mass storage 196 may be located in the controller 192. The display 198 is a monitor for displaying an image reconstructed from the image data from the x-ray detector assembly 252(1), although other types of display devices can be used. The image data or reconstructed image may also be communicated by the controller 192 to other systems.

The controller 192 transmits carriage control signals to the carriage drive system 215 and receives carriage position signals which identify the position of the carriage system 204(1) and the rotor system 206(1), although other configurations for controlling the carriage drive system 215 can be used. Additionally, the controller 192 transmits rotor control signals to the rotor drive system 227 and receives rotor position signals which identify the position and rotational speed of the rotor system 206(1), although other configurations for controlling the rotor drive system 227 can be used. The controller 192 also receives image data for reconstruction, storage, and display from the x-ray detector assembly 252(1), although other configurations can be used, such as having the controller 192 transmit detector control signals to the detector assembly 252(1).

The controller 192 transmits x-ray source control signals to the power source 194 which is coupled to supply high-voltage power to the x-ray source 248 in response to these control signals. The controller 192 also receives x-ray source status signals regarding the status of power being supplied to the x-ray source 248, although other configurations for controlling the power source 194 and the x-ray source 248 can be used.

The controller 192 is also coupled to the collimator 262 (shown in FIG. 1A) in CT scanner 200(1) and provides control signals for adjusting the size of the opening in the collimator 262 is so that the thickness and profile of the scanned slice can be varied according to the type of scan to be performed. The controller 192 is also coupled to the rotational encoder 236 (shown in FIG. 1A) which measures the angular position of the rotor system 206 and transfers that position information to the controller 192 for use in generating the rotor control signals.

The operation of the CT scanner 200(1) in the scanning system 190 will be described with reference to FIGS. 1A, 1B, and 4. To operate the CT scanner 200(1), the subject S remains on a hospital bed with the subject's head H supported on the platform 300. The subject S or scanner 200(1) is moved so as to position the subject's head H within the scanner cavity 267, such that the slice plane 256 coincides with the position of the first desired slice. If necessary, the height of the bed is adjusted to bring the subject's head H to the height of the scanner cavity 267. Positioning may be facilitated by light markers or other alignment device or techniques. A radiation shield 400 may be placed over the subject S prior to initiating the scan.

Once the subject S and radiation shield 400 are properly positioned, the x-ray source 248 is energized and rotation of rotor system 206 is initiated. As the x-ray exposure proceeds, projection data is acquired from the detector assembly 252(1) and is transferred to the controller 192 as previously discussed with regard to FIG. 4. Once the desired rotation angle of the rotor system 206(1) is traversed about the rotation axis A-A, image data collection for that particular slice is complete.

Once data collection for a particular slice is complete, the carriage system 204(1) is translated to a new position along the linear axis B-B and image data corresponding to the next slice (or multiple slices) is acquired. The process repeats until the entire volume of interest is scanned. As image data is received by the controller 192, it may be stored in the mass storage 196 and cross sectional slice images may be reconstructed and viewed on the display 198. The images may then be stored, displayed, communicated to remote computer stations, and processed to form volumetric images.

The operation described above applies to scanning in “step and shoot” mode. The CT scanner 200(1) may also be operated in spiral mode yielding similar results. Additionally, the scanner can be used in “scanogram” mode, also called “scout” or “pilot” views, where data is acquired while the slice plane 256 is moved relative to the subject S without rotation of the rotor assembly 206, yielding a projected image. This type of projection operation is especially convenient for verifying proper positioning of the subject S prior to beginning transverse slice acquisitions.

Persons skilled in the art will appreciate that the CT scanner 200(1) can be used for scanning extremities (hands and legs), folded elbows and knees, entire bodies of babies, small size pets, and various articles of appropriately small dimensions. CT scanner 200(1) may also be used to scan the female breast since the slice plane 256 is at or near the front surface 259 of the CT scanner 200(1).

The operation of the CT scanner 200(2) in the scanning system 190 is identical to the operation of CT scanner 200(1) in the scanning system 190, except as described below. In the operation of the CT scanner 200(1), as the carriage system 204(1) moves the rotor system 206(2) along the linear axis B-B from slice position to slice position, so does the entire detector ring 604. This embodiment can be used in “step and shoot” mode where the carriage system 204(1) is moved incrementally between slice acquisitions and in spiral mode where there is continuous data acquisition in a spiraling pattern as the carriage moves continuously during x-ray exposure. This fourth generation scanner system is a simpler design than the previous third generation system because less hardware is required to be mounted on the rotor system 206. Therefore fewer signals and less power must be transferred to and from the rotor system 206.

The operation of the CT scanner 200(3) in the scanning system 190 is identical to the operation of the CT scanner 200(1) in the scanning system 190, except as described below. After an image slice is obtained, CT scanner 200(3) does not move the carriage system 204(2) along the linear axis B-B because carriage system 204(2) is fixed to base 202. Instead, the CT scanner 200(3) may incrementally adjust the angle of the rotor system 206(1) with respect to the carriage system 204(2) and periodically capture an image slice of the head H or other region being examined. The entire head H of the subject S can be imaged by tilting the rotor system 206(1) through a range of motion where the position of the scan plane 256 is altered using the angular position adjustment system to move the rotor system 206(1) with respect to the carriage system 204(2) as described earlier. In this fashion, head scans may be completed without the need for an additional transverse carriage system.

Having thus described the basic concept of the invention, it will be readily apparent to those skilled in the art that the foregoing detailed disclosure is intended to be presented by way of example only, and is not limiting. Various alterations, improvements and modifications will occur and are intended to those skilled in the art, though not expressly stated herein. These modifications, alterations and improvements are intended to be suggested hereby, and are within the spirit and scope of the invention. Accordingly, the invention is limited only by the following claims and equivalents thereto.

1. A computed tomography scanner comprising:
(a) a base system;
(b) a rotor system having an axle rotationally mounted to said base system;
(c) at least one x-ray source mounted to said rotor system; and
(d) a power interface system at least partially disposed about said axle and that couples power to said x-ray source.

2. The scanner of claim 1 wherein said power interface system further comprises at least one slip ring assembly on said axle.

3. The scanner of claim 1 wherein said power interface system further comprises a cable assembly that winds and unwinds about said axle as said rotor system rotates.

4. The scanner of claim 1 further comprising a control signal interface system which is at least partially disposed about said axle and which transfers control signals to said rotor system.

5. The scanner of claim 4 wherein said control signal interface system further comprises at least one slip ring assembly on said axle.

6. The scanner of claim 4 wherein said control signal interface system further comprises a cable assembly that winds and unwinds about said axle as said rotor system rotates.

7. The scanner of claim 1 further comprising an x-ray detector assembly mounted to said rotor system and an image data interface system which is at least partially disposed about said axle and which transfers image data from said x-ray detector assembly.

8. The scanner of claim 7 wherein said image data interface system further comprises at least one slip ring assembly on said axle.

9. The scanner of claim 7 wherein said image data interface system further comprises a cable assembly that winds and unwinds about said axle as said rotor system rotates.

10. A computed tomography scanner system comprising:
(a) a base system;
(b) a rotor system having an axle rotationally mounted to said base system;
(c) at least one x-ray source mounted to said rotor system;
(d) a power source producing power; and
(e) a power interface system at least partially disposed about said axle and that couples said power to said x-ray source.

11. The scanner system of claim 10 wherein said power interface system further comprises at least one slip ring assembly on said axle.

12. The scanner system of claim 10 wherein said power interface system further comprises a cable assembly that winds and unwinds about said axle as said rotor system rotates.

13. The scanner system of claim 10 further comprising a controller and a control signal interface system which is at least partially disposed about said axle and which transfers control signals from said controller to said rotor system.

14. The scanner system of claim 13 wherein said control signal interface system further comprises at least one slip ring assembly on said axle.

15. The scanner system of claim 13 wherein said control signal interface system further comprises a cable assembly that winds and unwinds about said axle as said rotor system rotates.

16. The scanner system of claim 10 further comprising a controller, an x-ray detector assembly mounted to said rotor system, and an image data interface system which is at least partially disposed about said axle and which transfers image data from said x-ray detector assembly to said controller.

17. The scanner system of claim 16 wherein said image data interface system further comprises a slip ring assembly on said axle.

18. The scanner system of claim 16 wherein said image data interface system further comprises a cable assembly that winds and unwinds about said axle as said rotor system rotates.

19. A method for making a computed tomography scanner comprising the steps of:
(a) providing a base system;
(b) providing a rotor system having an axle;
(c) mounting said axle to said base system for rotational movement;
(d) mounting at least one x-ray source to said rotor system; and
(e) providing a power interface system at least partially disposed about said axle and that couples power to said x-ray source.

20. The method of claim 19 wherein said power interface system comprises at least one slip ring assembly on said axle.

21. The method of claim 19 wherein said power interface system comprises a cable assembly that winds and unwinds about said axle as said rotor system rotates.

22. The method of claim 19 further comprising providing a control signal interface system which is at least partially disposed about said axle and which transfers control signals to said rotor system.

23. The method of claim 22 wherein said control signal interface system comprises at least one slip ring assembly on said axle.

24. The method of claim 22 wherein said control signal interface system comprises a cable assembly that winds and unwinds about said axle as said rotor system rotates.

25. The method of claim 1 further comprising mounting an x-ray detector assembly to said rotor system and providing an image data interface system which is at least partially disposed about said axle and which transfers image data from said x-ray detector assembly.

26. The scanner of claim 25 wherein said image data interface system comprises at least one slip ring assembly on said axle.

27. The scanner of claim 25 wherein said image data interface system comprises a cable assembly that winds and unwinds about said axle as said rotor system rotates.

28. A method for making a computed tomography scanner system comprising the steps of:
(a) providing a base system;
(b) providing a rotor system having an axle;
(c) mounting said axle to said base system for rotational movement;
(d) mounting at least one x-ray source to said rotor system;
(e) providing a power source that produces power; and
(f) providing a power interface system at least partially disposed about said axle and that couples said power to said x-ray source.

29. The method of claim 28 wherein said power interface system comprises at least one slip ring assembly on said axle.

30. The method of claim 28 wherein said power interface system comprises a cable assembly that winds and unwinds about said axle as said rotor system rotates.

31. The method of claim 28 further comprising providing controller and a control signal interface system which is at least partially disposed about said axle and which transfers control signals from said controller to said rotor system.

32. The method of claim 31 wherein said control signal interface system comprises at least one slip ring assembly on said axle.

33. The method of claim 31 wherein said control signal interface system comprises a cable assembly that winds and unwinds about said axle as said rotor system rotates.

34. The method of claim 28 further comprising providing a controller, mounting an x-ray detector assembly to said rotor system, and providing an image data interface system which is at least partially disposed about said axle and which transfers image data from said x-ray detector assembly to said controller.

35. The scanner of claim 34 wherein said image data interface system comprises at least one slip ring assembly on said axle.

36. The scanner of claim 34 wherein said image data interface system comprises a cable assembly that winds and unwinds about said axle as said rotor system rotates.
